(19) United States
(12) Patent Application Publication
(10) Pub. No.: US 2004/0245280 A1
(43) Pub. Date: Dec. 9, 2004

(54) Anti-theft hopper for vending machine

(75) Inventors: Dennis Earl Schramm, Fresno, CA (US); Christopher Robin Craven, Fresno, CA (US)

Correspondence Address: BAKER BOTTS, LLP, 910 LOUISIANA, HOUSTON, TX, 77002-4995, US

(73) Assignee: THE VENDO COMPANY

(21) Appl. No.: 10/454,114

(22) Filed: Jun. 4, 2003

(51) Int. Cl. B65H 1/30; B65G 59/00; B65H 3/00; G07F 11/00; A47F 1/04; G07F 11/16

(52) U.S. Cl. 221/306; 221/179

(57) ABSTRACT

The present invention relates to a hopper for preventing theft of undispensed products from a vending machine. The disclosed anti-theft hopper receives dispensed products and allows customers to retrieve dispensed products, but prevents unauthorized access to the interior of a vending machine through the product delivery port. The anti-theft hopper has a first opening through which dispensed products enter the hopper and a second opening through which dispensed products are retrieved by customers. A hopper flap is pivotally coupled to the hopper, wherein the hopper flap is adaptable to pivotally swing over products dispensed into the hopper to allow consumers to retrieve dispensed products from the hopper and wherein the hopper flap is further adaptable to prevent unauthorized access to undispensed products by blocking the insertion of a protruding device through the hopper.

### TECHNICAL FIELD OF THE INVENTION

This invention relates in general to the field of vending machines, and more particularly, to an apparatus and method for preventing theft of vending products through the product delivery port.

### BACKGROUND OF THE INVENTION

Vending machines are widely used to dispense beverages, food, and other perishable and nonperishable goods. Vending machines are often placed at unattended and isolated locations where they must not only withstand harsh elements from the weather and the environment, but also withstand theft and vandalism. In particular, theft directed toward vending machines pose significant problems for operators and manufacturers in the vending industry, and the prevention thereof is an important consideration in the operation of vending machines.

A typical vending machine is a housing, which may be a cabinet, with an outer door at the front. Near the lower end of the outer door is a delivery port, an opening leading to a hopper from which a consumer may retrieve vended products. In a typical vending machine, the pathway from the exterior opening of the outer door through the hopper to the interior of the vending machine is largely unobstructed and unguarded, which exposes the delivery port of the vending machine to the problem of theft. A thief may steal products through the delivery port by means of a protruding device, including a physical or mechanical apparatus. For example, a thief may extend his arm through the opening of the outer door through the hopper to reach products inside the vending machine. Next, the thief may take hold of and withdraw products that are in queue to be dispensed.

In existing vending machines, the designs for product delivery ports and hoppers have failed to prevent, or even deter, theft via the delivery port. Existing vending machines are vulnerable because their delivery ports are largely unobstructed and unguarded by any mechanical barrier to prevent theft. Their vulnerability is compounded by the fact that vending machines are typically operated in unattended and isolated areas, thereby often allowing sufficient time for thieves to employ various methods to steal products from the vending machine. During such attempts of theft, vending machines may often be damaged and may require costly repairs and replacements.

Some attempts have been made to prevent theft through the delivery port of vending machines. For example, mechanical steel plates have been fastened to the eyelet opening at the outer door to reduce the size of the opening to the delivery port. However, a small eyelet opening presents difficulties for consumers when they are retrieving products. For example, rings, watches, and other jewelry worn by consumers get caught when vended products are retrieved from small openings.

Further, a smaller opening necessarily imposes unwanted restrictions on the size of products that can be dispensed by the vending machine. While such attempts to guard against theft have presented problems to consumers and disadvantages to vendors, they have had little effect in deterring theft, because a thief can circumvent such countermeasures by using a smaller arm or mechanical apparatus to navigate through the delivery port.

For vending machine operators, unauthorized access via the delivery port causes significant financial losses, which include the loss of vending products stored inside the machines, the cost of repair or replacement of the machines damaged by the theft, and the loss of sales revenues during the time that the machines are made inoperable by the theft.

Therefore, there is a strong and unmet need in the vending industry to provide vending machine designs that prevent theft to vending machines via the delivery port.

### SUMMARY OF THE INVENTION

The present invention is a product delivery hopper that is designed to prevent theft. When products are dispensed from a vending machine, the products are dropped into the bottom of a hopper. Inside the hopper is a hopper flap that may pivot to allow the products to drop easily into the hopper. The hopper flap may be made of metal, plastic, or other materials. The hopper flap may pivot past the dispensed products when consumers reach into the hopper to retrieve the dispensed products. The hopper flap prevents unauthorized individuals from inserting their arm or a mechanical device, such as a wire or stick, into the housing of the vending machine to dislodge and extract undispensed products.

It is an object of the present invention to provide an method and apparatus for preventing unauthorized access to the interior of a vending machine.

Another object of the present invention is to provide such a method and apparatus that prevent undispensed products inside the vending machine from being obtained through the delivery port by unauthorized use of a physical or mechanical device.

Another object of the present invention is to provide such a method and apparatus that reduce the incidence of theft from the vending machine without adding significant costs to the manufacturing and operating of such machines.

Another object of the present invention is to provide such a method and apparatus that are adaptable for use with existing vending machines that lack anti-theft hoppers.

A further object of the present invention is to provide such a method and apparatus that improve the ease of use for consumers when retrieving dispensed products from the delivery ports of vending machines.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows a perspective view of a vending machine.

FIG. 2 shows a perspective view of an embodiment of the present invention.

FIG. 3 provides a detailed perspective view of the embodiment of FIG. 1.

FIGS. 4A-4C are schematic side views of various embodiments of the anti-theft hopper.

### DETAILED DESCRIPTION OF THE INVENTION

Various methods and apparatus for the anti-theft hopper are disclosed. The subject of the invention will be described with reference to numerous details set forth below, and the accompanying drawings will illustrate the invention. The following description of the drawings are illustrative of the invention and are not to be construed as limiting the invention. Numerous specific details are described to derive a thorough understanding of present invention. However, in certain circumstances, well known, or conventional details are not described in order not to obscure the present invention in detail.

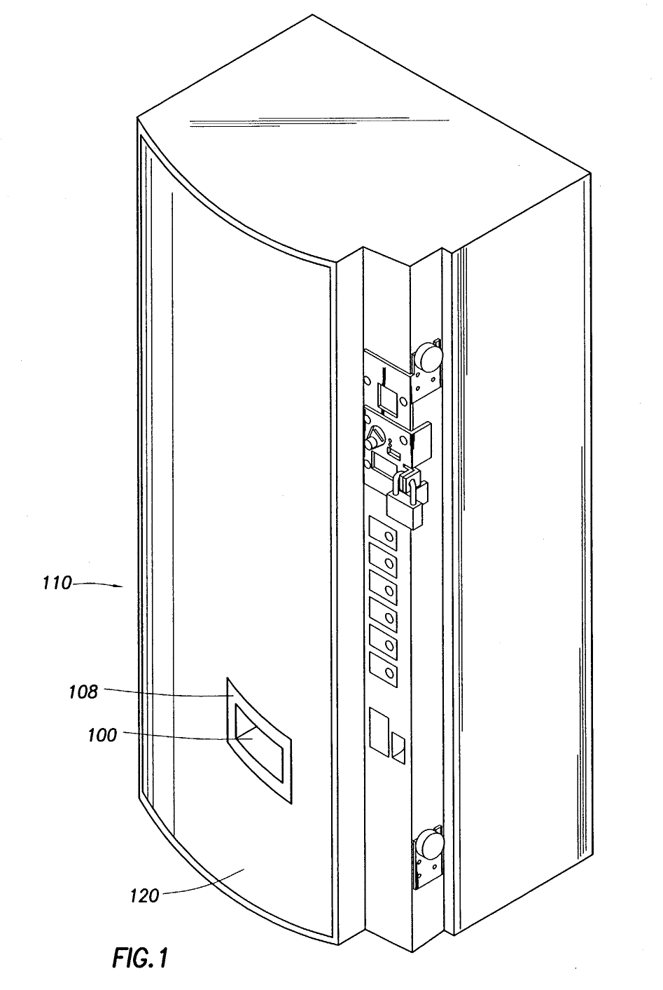

FIG. 1 shows a vending machine 110 with front outer door 120. Near the lower part of front outer door 120 is eyelet opening 108. Behind eyelet opening 108 is hopper 100. When products are dispensed from vending machine 110, the products rest in hopper 100, and customers may retrieve the products from hopper 100 through eyelet opening 108.

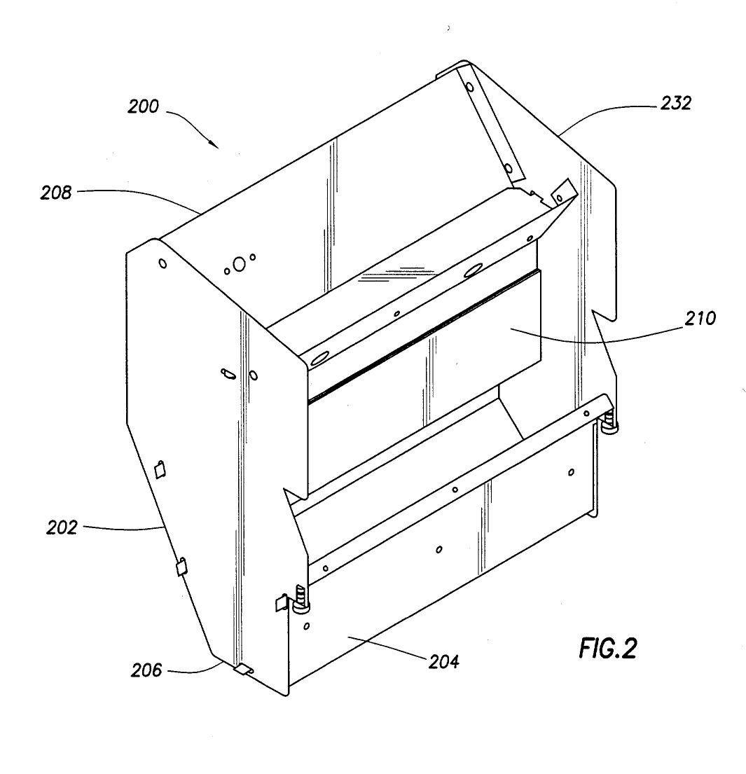

FIG. 2 illustrates an embodiment of the present invention, depicting an anti-theft hopper 200 that may be attached at the position of eyelet opening 108 (as shown in FIG. 1) to outer door 120 of a vending machine 110 (as also shown in FIG. 1). Hopper 200 has a front side 202, a back side 204, and a bottom side 206. Hopper 200 may also be viewed as a delivery port from which a consumer may retrieve vended products. When products are dispensed from a vending machine, the products enter hopper 200 through hopper back side 204 and rest on hopper bottom 206. Eyelet opening 208 (which corresponds to eyelet opening 108 of FIG. 1) in hopper front side 202 is the customer's entry way for reaching vended products that are dispensed into hopper 200. Reaching through opening 208, a customer will encounter hopper flap 210. Hopper flap 210 is a barrier inside hopper 200 that may pivot to allow the products to drop into hopper 200. Then, hopper flap 210 may pivot past the dispensed products when consumers reach into hopper 200 to retrieve the dispensed products. Hopper flap 210 prevents unauthorized individuals from inserting their arm or a mechanical device, such as a wire or stick, through the delivery port of the vending machine to dislodge and extract undispensed products. Hopper flap 210 is a barrier that obstructs the pathway that extends from opening 208 in the outer door through hopper 200 and through hopper back side 204 to the interior of the vending machine. As noted above, it is common for thieves to attempt to insert a protruding device through the delivery port of a vending machine in order to reach products inside the vending machine. Hopper flap 210 serves as an effective barrier to deny such unauthorized access and prevents theft.

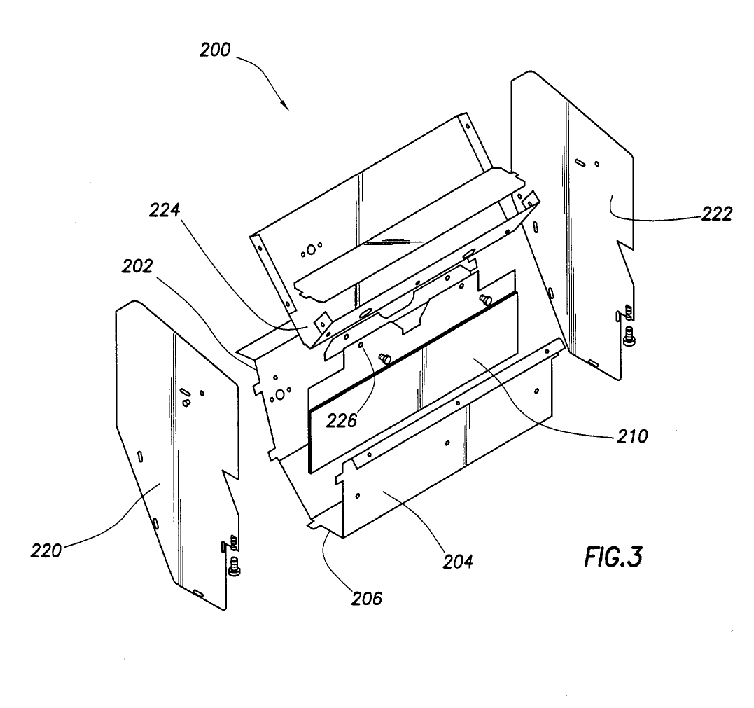

FIG. 3 illustrates a detailed perspective view of the embodiment of FIG. 2. Anti-theft hopper 200 is shown. Hopper 200 has a front side 202, a back side 204, a bottom side 206, a right side 220, and a left side 222. Hopper flap 210 is positioned inside hopper 200 and between hopper front side 202 and hopper back side 204. Hopper flap 210 is pivotally coupled to hopper 200 at hopper top 224. In the present embodiment, the attach point 226 at which hopper flap 210 is attached to hopper 200 is substantially at a midpoint between hopper front side 202 and hopper back side 204.

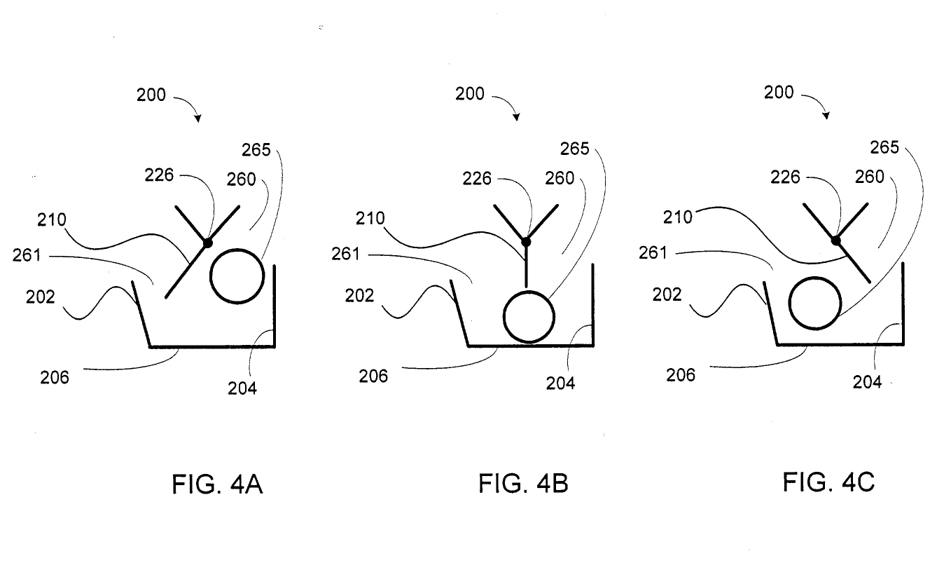

FIGS. 4A-4C illustrate several exemplary positions of hopper flap 210 as it operates in anti-theft hopper 200. Hopper 200 has two hopper openings 260 and 261. When products 265 are dispensed by the vending machine, products 265 enter hopper 200 through hopper opening 260. When retrieving products 265 purchased from the vending machine, customers retrieve products 265 from hopper 200 through hopper opening 261, which is positioned in the front outer door of the vending machine and corresponds to eyelet opening 108 of FIG. 1. Hopper flap 210 is pivotally coupled to hopper 200, allowing hopper flap 210 to pivotally swing from one position to another. Hopper flap 210 may swing through the three exemplary positions shown in FIG. 4A-4C.

FIG. 4A shows a first exemplary position of hopper flap 210, wherein hopper flap 210 is positioned to allow products 265 to enter the hopper through hopper opening 260. In this position, hopper flap 210 closes hopper opening 261 and thus prevents thieves from inserting their arm or a mechanical device into hopper 200. Then, hopper flap 210 may pivotally swing to its next position.

FIG. 4B shows a second exemplary position of hopper flap 210, wherein hopper flap 210 is at a resting position above products 265 dispensed in hopper 200. Hopper bottom 206 is configured to allow a horizontally laying product 265 to rest in such a position as to allow hopper flap 210 to swing freely above. Next hopper flap 210 may continue to swing to its next position.

FIG. 4C shows a third exemplary position of hopper flap 210, wherein hopper flap 210 is positioned to allow products 265 to be retrieved from hopper 200 through hopper opening 261. In this position, hopper flap 210 closes hopper opening 260 and thus prevents thieves from inserting their arm or a mechanical device through hopper 200 into the inside of the vending machine.

In the above embodiments, hopper flap 210 is positioned inside hopper 200 and between hopper front side 202 and hopper back side 204. Hopper flap 210 is pivotally coupled to hopper 200 at hopper top 224. In the above embodiments, the attach point at which hopper flap 210 is attached to hopper 200 is substantially at a midpoint between hopper front side 202 and hopper back side 204. It should be noted that many other embodiments are possible wherein the point at which hopper flap 210 is attached to hopper 200 may be shifted to a point closer to either hopper front side 202 or hopper back side 204. It should also be noted that the dimensions of any of the parts described herein, such as hopper flap 210, hopper front side 202, hopper back side 204, and hopper bottom 206, may be altered to provide other embodiments that are adaptable to prevent unauthorized access to the interior of a vending machine. It should further be noted that any of these embodiments may be modified in combination and in like manner as those illustrated in FIGS. 4A-4C.

While specific embodiments of the present invention have been illustrated and described, it is to be understood that the invention is not limited to the precise configuration and components disclosed herein. Various modifications, changes, and variations, which will be apparent to those skilled in the art, may be made in the arrangement and operation of the methods and apparatus of the present invention disclosed herein without departing from the spirit and scope of the invention. These modifications can be made to the invention in light of the above detailed description. Moreover, while alternative embodiments and specifics of the present invention have been described, one skilled in the art will appreciate that many features of one embodiment are equally applicable to other embodiments.

What is claimed is:

1. A vending machine, comprising:
a housing for storing products to be dispensed;
a front door coupled to the housing;
a hopper for receiving products dispensed by the vending machine, the hopper having a first hopper opening through which products dispensed by the vending machine enter the hopper and a second hopper opening positioned in the front door through which dispensed products are retrieved by customers; and
a hopper flap pivotally coupled to the hopper, wherein the hopper flap is adaptable to pivotally swing to a position that closes one of the hopper openings.

2. The vending machine of claim 1, wherein the hopper flap is positioned to allow products to enter the hopper through the first hopper opening and at the same time is positioned to close the second hopper opening.

3. The vending machine of claim 1, wherein the hopper flap is at a resting position above the products dispensed in the hopper.

4. The vending machine of claim 1, wherein the hopper flap is positioned to allow products to be retrieved from the hopper through the second hopper opening and at the same time is positioned to close the first hopper opening.

5. The vending machine of claim 1, wherein the hopper flap is adaptable to pivotally swing
from a first hopper flap position, wherein the hopper flap is positioned to allow products to enter the hopper through the first hopper opening and at the same time is positioned to close the second hopper opening,
to a second hopper flap position, wherein the hopper flap is at a resting position above the products dispensed in the hopper,
to a third hopper flap position, wherein the hopper flap is positioned to allow products to be retrieved from the hopper through the second hopper opening and at the same time is positioned to close the first hopper opening.

6. The vending machine of claim 5, wherein the hopper further comprises a front side, a back side, and a bottom side.

7. The vending machine of claim 6, wherein the hopper flap is pivotally coupled substantially at a midpoint between the hopper front side and the hopper back side.

8. The vending machine of claim 6, wherein the hopper flap is pivotally coupled at a point substantially closer to the hopper front side than the hopper back side.

9. The vending machine of claim 6, wherein the hopper flap is pivotally coupled at a point substantially closer to the hopper back side than the hopper front side.

10. An apparatus for use with product vending, comprising:
a hopper for receiving products dispensed a vending machine, the hopper having a first hopper opening through which products dispensed by the vending machine enter the hopper and a second hopper opening positioned through which dispensed products are retrieved by customers; and
a hopper flap pivotally coupled to the hopper, wherein the hopper flap is adaptable to pivotally swing to a position that closes one of the hopper openings.

11. The apparatus of claim 10, wherein the hopper flap is positioned to allow products to enter the hopper through the first hopper opening and at the same time is positioned to close the second hopper opening.

12. The apparatus of claim 10, wherein the hopper flap is at a resting position above the products dispensed in the hopper.

13. The apparatus of claim 10, wherein the hopper flap is positioned to allow products to be retrieved from the hopper through the second hopper opening and at the same time is positioned to close the first hopper opening.

14. The apparatus of claim 10, wherein the hopper flap is adaptable to pivotally swing
from a first hopper flap position, wherein the hopper flap is positioned to allow products to enter the hopper through the first hopper opening and at the same time is positioned to close the second hopper opening,
to a second hopper flap position, wherein the hopper flap is at a resting position above the products dispensed in the hopper,
to a third hopper flap position, wherein the hopper flap is positioned to allow products to be retrieved from the hopper through the second hopper opening and at the same time is positioned to close the first hopper opening.

15. A method for preventing unauthorized access to a vending machine, comprising the steps of:
storing products to be dispensed in the vending machine;
dispensing products into a hopper;
receiving products dispensed by the vending machine, the hopper having a first hopper opening through which products dispensed by the vending machine enter the hopper and a second hopper opening through which dispensed products are retrieved by customers; and
providing a hopper flap pivotally coupled to the hopper, wherein the hopper flap is adaptable to pivotally swing to a position that closes one of the hopper openings.

16. The method of claim 15, further comprising the steps of:
allowing products to enter the hopper through the first hopper opening; and at the same time
closing the second hopper opening.

17. The method of claim 15, further comprising the step of:
positioning the hopper flap at a resting position above the products dispensed in the hopper.

18. The method of claim 15, further comprising the steps of:
allowing products to be retrieved from the hopper through the second hopper opening; and at the same time
closing the first hopper opening.

19. The method of claim 15, further comprising the step of:
swinging the hopper flap
from a first hopper flap position, wherein the hopper flap is positioned to allow products to enter the hopper through the first hopper opening and at the same time is positioned to close the second hopper opening,
to a second hopper flap position, wherein the hopper flap is at a resting position above the products dispensed in the hopper,
to a third hopper flap position, wherein the hopper flap is positioned to allow products to be retrieved from the hopper through the second hopper opening and at the same time is positioned to close the first hopper opening.
